(19) United States
(12) Patent Application Publication
(10) Pub. No.: US 2014/0023456 A1
(43) Pub. Date: Jan. 23, 2014

(54) Armor Bolts

(71) Applicants: Richard L. Allor, Livonia, MI (US); Dainius E. Skiotys, Farmington Hills, MI (US)

(72) Inventors: Richard L. Allor, Livonia, MI (US); Dainius E. Skiotys, Farmington Hills, MI (US)

(73) Assignee: Ceradyne, Inc.

(21) Appl. No.: 13/556,055

(22) Filed: Jul. 23, 2012

(51) Int. Cl. F16B 35/00; B23K 11/00

(52) U.S. Cl. 411/396; 470/11

(57) ABSTRACT

An armor bolt, that is, a bolt in which the bolt head is fabricated from an armor plate and then attached, such as by welding, to a threaded stud or shaft to form the threaded portion of the armor bolt. A preferred embodiment of the invention employs a hex-shaped bolt head cut with a laser or water jet cutter from armor steel plate meeting Mil-A-12560 or Mil-A-46100. The diameter of the bolt head is determined by the hole size in the armor to be attached to the vehicle and the diameter of the threaded stud or shaft. The thickness or height of the bolt head is dictated by the ballistic threat it needs to stop. The threaded shaft in a preferred embodiment is resistance welded to be perpendicular to the head at the center of one face of the hex head.

### BACKGROUND OF THE INVENTION

1. Field of the Invention

The present invention relates generally to the field of vehicle. armor and more specifically to bolts used to retain armor to vehicles. The bolts of the present invention are made by cutting a bolt head from armor steel plate and then welding a threaded shaft thereto. They can then be used to replace more conventional bolts that may or may not have armor washers.

2. Background Discussion

When American troops first took Baghdad only the U.S. military police had fully armored vehicles. During the occupation that followed the 2003 invasion that toppled Saddam Hussein's regime, insurgent forces deployed roadside bombs, RPG teams and snipers with small arms to attack military vehicles on supply convoys and other known routes.

To protect themselves from these threats, American troops began reinforcing their Humvees and other vehicles with whatever materials were available.

The Army began deploying ‘up-armor’ kits to better protect military vehicles in August 2003. Three levels of ‘up-armor’ were implemented:
Level 1: fully integrated armor installed during vehicle production or retrofit (including ballistic windows)
Level II: add-on armor (including ballistic windows)
Level III: locally fabricated armor (interim solution, lacking ballistic windows)

The United States Marines developed their own Marine Armor Kit (MAK), consisting of bolt-on armor for the crew compartment, ballistic glass, suspension upgrades, and air conditioning.

The purpose was to install an armor package on the outside of a vehicle. The goal was to make the installation process easy, reduce the number of parts in a vehicle build and reduce second projectiles of failed bolts that could propel into the passenger cabin.

In the past when installing armor on the side of a vehicle, each time a bolt was used, an armor washer was needed to prevent a ballistic leak around the bolt hole in the armor panel.

Unfortunately, this attempt to bolster the ballistic resistance of a conventional bolt adds another part to each such bolt and still leaves the installation vulnerable to the chance of a secondary projectile entering the vehicle interior. Therefore, it would be highly advantageous to provide an armor bolt that is resistant to ballistic impact and obviates the present requirement for an added armor washer.

### SUMMARY OF THE INVENTION

The present invention meets this need in the form of an armor bolt, that is, a bolt in which the bolt head is fabricated from an armor plate and then attached, such as by welding, to a threaded stud or shaft to form the threaded portion of the armor bolt. A preferred embodiment of the invention employs a hex-shaped bolt head cut with a laser or water jet cutter from armor steel plate meeting Mil-A-12560 or Mil-A-46100. The diameter of the bolt head is determined by the hole size in the armor to be attached to the vehicle and the diameter of the threaded stud or shaft. The thickness or height of the bolt head is dictated by the ballistic threat it needs to stop. The threaded shaft in a preferred embodiment is resistance welded to be perpendicular to the head at the center of one face of the hex head, such as by employing a Nelson Stud Welding Gun. An analysis of test samples using different welding processes (i.e., resistance welding, TIG welding and MIG welding) shows that while each is satisfactory for fabricating an armor bolt, resistance welding is fastest, produces a lower material temperature and has higher pull strength and higher micro-hardness near the weld area. More importantly, an armor bolt made in accordance with the present invention by resistance welding out-performs a standard bolt and washer as well as armor washer and bolt systems in ballistic testing and eliminates secondary projectiles upon ballistic impact.

With this process any vehicle can use armor bolts no matter what the size or shape of bolt that is needed and it could be used in an aftermarket process for replacement parts as well, with no risk of losing washers.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is an illustration of a vehicle frame showing typical boss locations where an armor bolt of the present invention could be used to attach armor to the vehicle;

FIG. 2A shows the current method of a standard bolt with an armor washer;

FIG. 2B shows the new invention of a one-piece armor bolt;

FIG. 3B shows the current attaching method using a washer and standard bolt;

FIG. 3C shows the new invention using an armored hex head, cut from armor plate, without an armor washer;

FIG. 4 is a graph of temperature for different welding techniques;

FIG. 5 is a graph of welding time for such welding techniques;

FIG. 6 is a graph of mirco-hardness v. distance for the different welding techniques;

FIG. 7 is a graph of pull-off load versus displacement for the different welding techniques;

FIG. 8 is a drawing of a panel of standard bolts and washers tested. In this test, all bolts and washers failed when shot and the threaded shaft was pushed through the panel as a secondary projectile;

FIG. 9 is a drawing of standard bolts and armor washers tested. In this test all bolts and washers failed when shot and some of the threaded shafts were pushed through the panel as a secondary projectile; and

FIG. 10 is a drawing of a panel of armor bolts tested. In this test all bolts passed when shot and produced no secondary projectiles.

### DETAILED DESCRIPTION OF A PREFERRED EMBODIMENT

Referring to the accompanying drawings, the invention hereof will be explained by illustration of an exemplary embodiment without any intent to limit the scope hereof to that particular example.

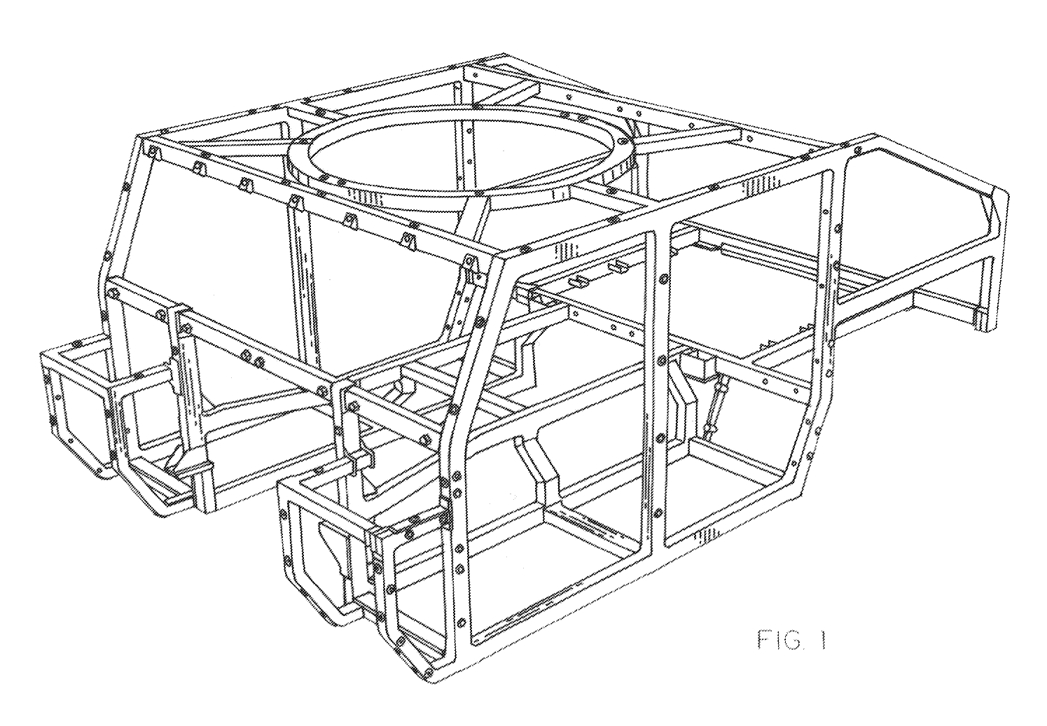

In a typical vehicle frame shown in FIG. 1 that would need to be up armored, there are over a hundred boss locations that could use this inventive armor bolt.

The invention comprises an armor bolt which obviates an armor washer and eliminates the secondary projectile into the crew cabin while maintaining the highest material properties possible while armoring a vehicle typically using resistance welding.

This invention can be used on all new vehicle builds or as a replacement for the current method of attaching up armor to vehicles.

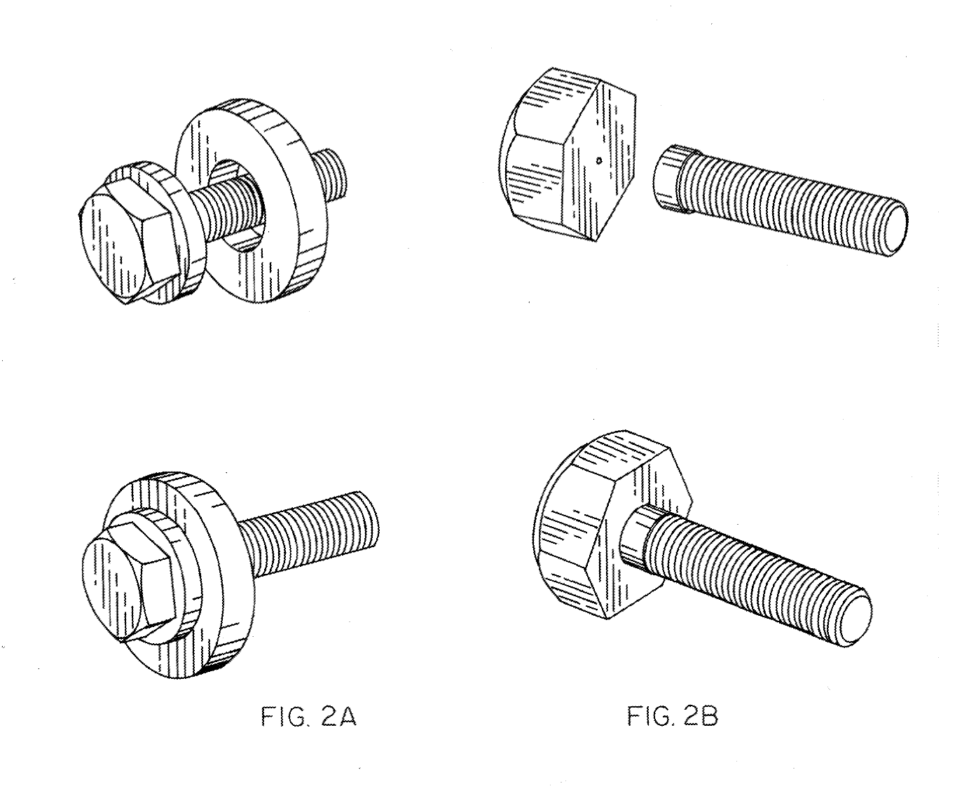

FIG. 2A shows the current method of using a standard bolt with an armor washer. FIG. 2B shows the new invention of a one piece armor bolt.

In the current method depicted in FIG. 2A, it is seen that a non-armor bolt is typically reinforced by integrating an armor washer between the bolt head flange and the surface of the armor plate being attached to a vehicle. Non-assembled and assembled configurations are shown therein. In the inventive method depicted in FIG. 2B, the head of the bolt is itself armored and is welded to the threaded shaft or stud at the center of its back face or flat interior-facing surface. Pre-welded and welded configurations are shown therein.

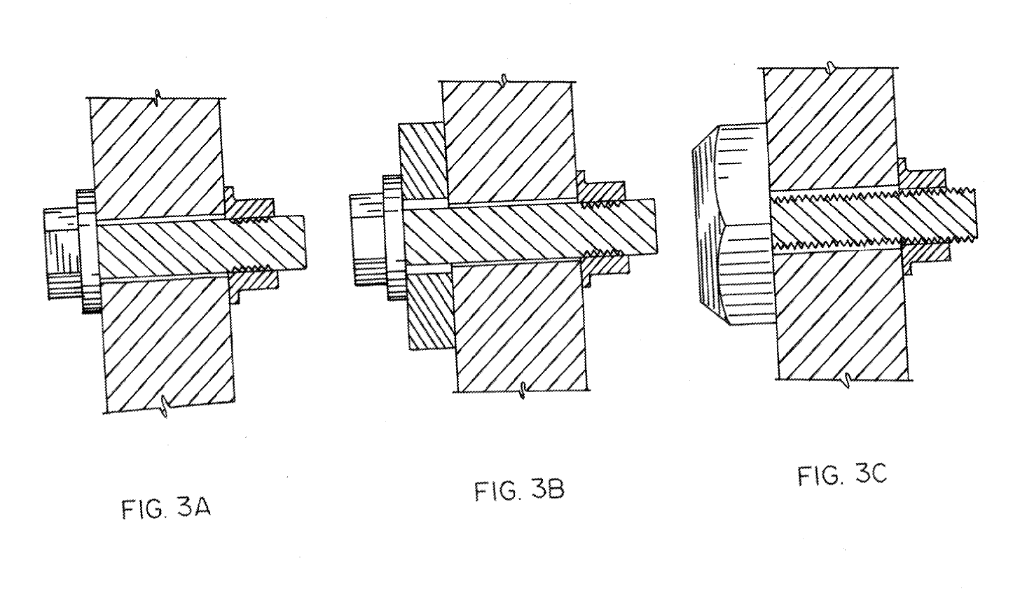

FIG. 3B shows the current armor attaching method using a washer and standard bolt. The hex head of the bolt can shatter upon ballistic impact and drive the threaded shaft and nut into the passenger cabin as a secondary projectile. In the prior art method an armor washer is used in the attachment of the armor. FIG. 3A shows a possible ballistic leak when not using an armor washer. FIG. 3C shows the present invention using an armored hex head, but from armor plate, without an armor washer. The increased size of the hex now performs the same function as the armor washer and the material will not shatter. The threaded stud is welded to the back face of the armor hex nut.

### MANUFACTURING

The hex is cut from armor steel plate, such as plate meeting specifications Mil-A-12560 or Mil-A-46100, with a laser or waterjet cutting equipment. The diameter of the hex is determined by the hole size in the armor and the bolt diameter. The thickness is determined by the threat that is needed to stop. The threaded shaft is welded to the center of one face of the hex nut with resistance welding using a Nelson Stud Welding Gun.

### TESTING

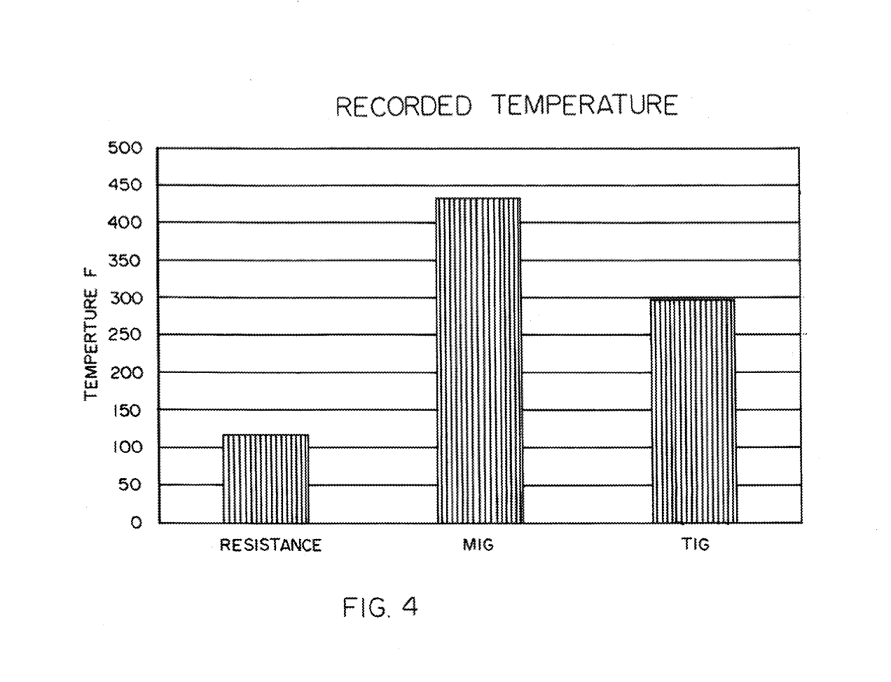

Test samples were made using three different welding processes, MIG Welding, TIG Welding and resistance welding. “MIG” stands for metal inert gas welding and “TIG” for tungsten inert gas welding. Both are types of arc welding. A temperature measurement was taken on each sample on the back side of the test sample while welding. As shown in FIG. 4, the resistance welding has the lowest temperature as measured on the armor plate.

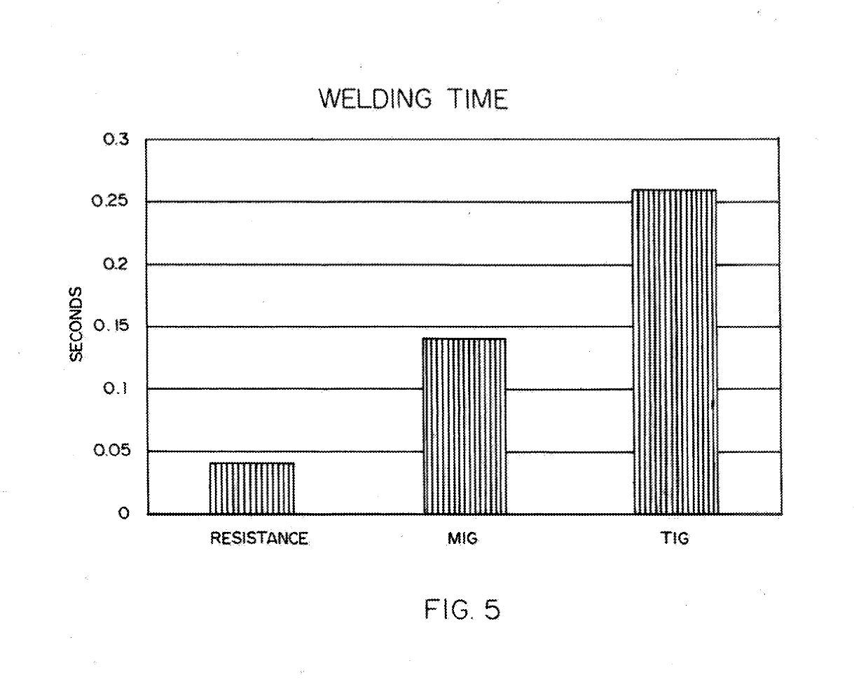

A time study was conducted of each welding process to attach the threaded shaft to the armor hex head FIG. 5 shows that the resistance welding was the fastest method to attach the threaded shaft and TIG Welding took the most time.

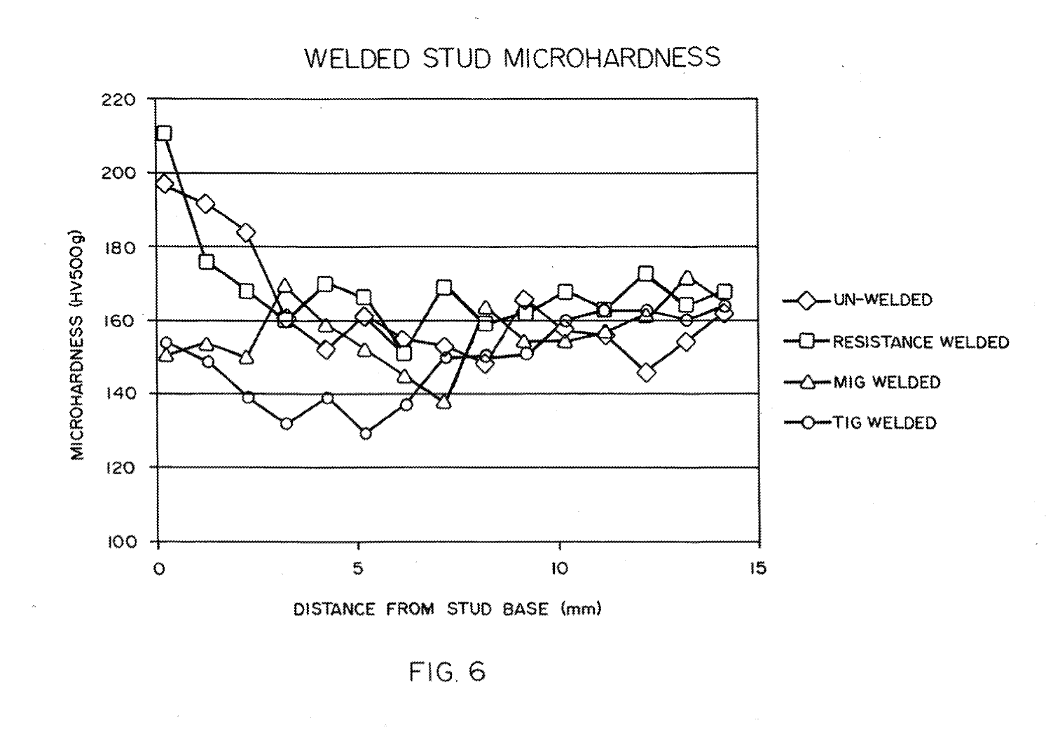

Micro-hardness of each stud was measured after welding. An un-weld stud was included as a baseline and compared to the welded studs. FIG. 6 shows that less than 2 mm distance from the weld point of the stud, the micro-hardness of the MIG and TIG welded samples has a lower measured hardness when compared to the resistance welded stud. The un-welded and the resistance welded studs are the same hardness. The micro-hardness of all studs is the same hardness at around 10 mm from the weld surface.

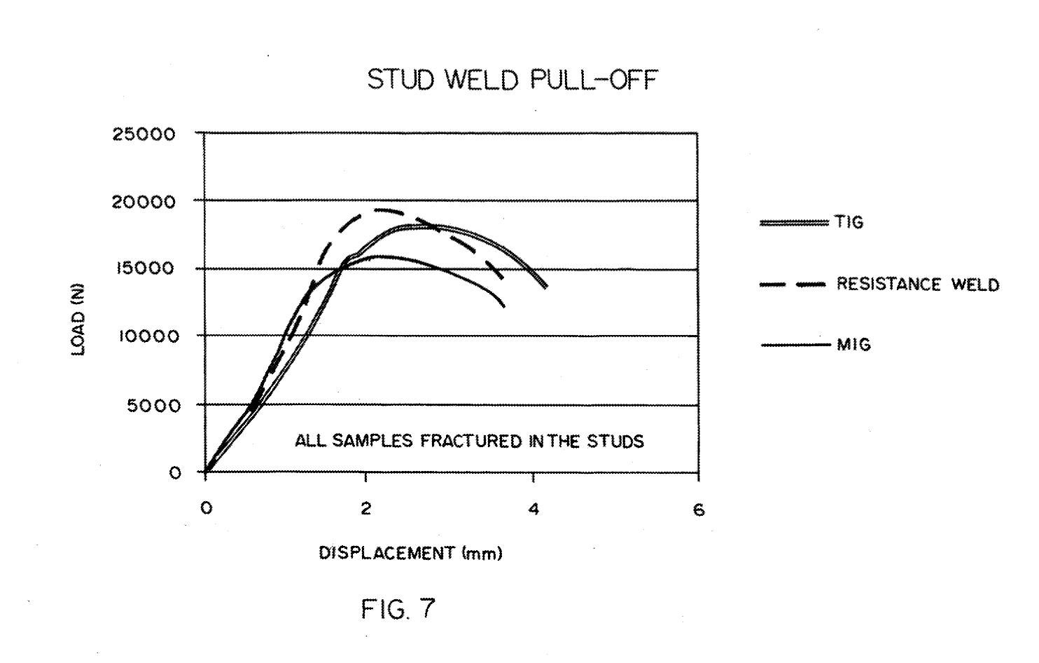

Each welding process was used to make pull test samples of the armor material as the base material and a stud welded to it with each process. FIG. 7 shows that each sample was pull tested to failure. This study showed that the resistance welded sample had the highest failure load in pull testing. All failures occurred in the stud and not in the base material.

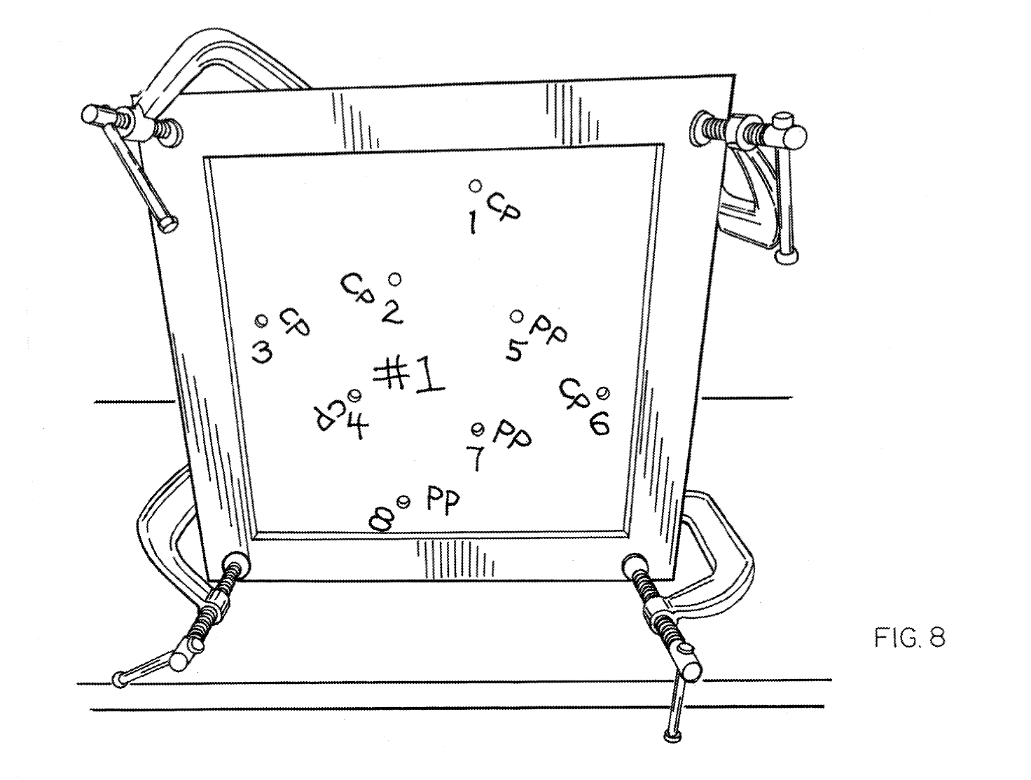

FIG. 8 is a photograph of a panel of standard bolts and washer ballistically tested. In this test all bolts and their washer failed when shot and the threaded shaft was pushed through the panel as a secondary projectile.

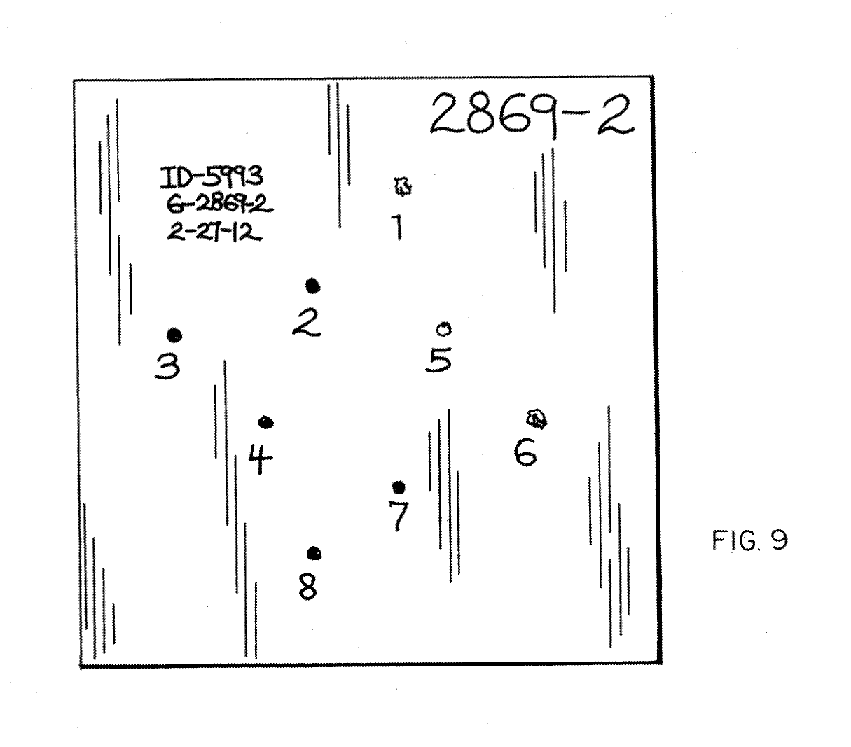

FIG. 9 is a photograph of a panel of standard bolts and armor washers ballistically tested. In this test all bolts and their washer failed when shot and then some of the threaded shafts were pushed through the panel as a secondary projectile.

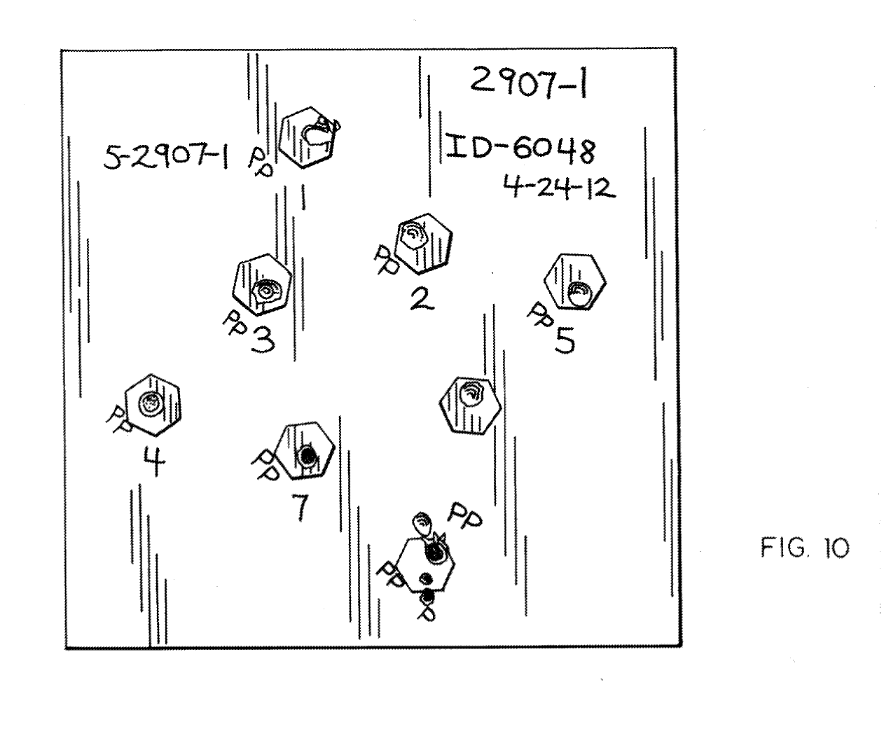

FIG. 10 is a photograph of inventive armor bolts ballistically tested. In this test all bolts passed (stopped the projectile) when shot and produced no secondary projectiles.

### CONCLUSION

Manufacturing an armor bolt using resistance welding therefore has these advantages:
Outperforms standard bolt and washer and the armor washer and bolt systems in ballistic testing;
Eliminates the secondary projectile;
Quicker than other welding processes;
Higher pull strength;
Higher micro-hardness near the weld area;
Lower material temperature during welding;
Fewer parts than using armor washers.

It will now be understood that the present invention comprises an armor bolt, that is, a bolt for attaching armor to a vehicle wherein the bolt comprises a head made from armor plate steel and cut into a hex shape with the necessary diameter and thickness to stop the threat, prevent secondary projectiles within the vehicle, prevent ballistic leaks and obviate the need for armor washers. The head is preferably welded to a threaded stud which in the preferred embodiment is carried out using resistance welding. The invention herein is to be deemed limited only to the appended claims and their legal equivalents.

We claim:

1. A bolt apparatus for attaching armor to a vehicle to increase penetration resistance to ballistic projectiles; the bolt apparatus comprising:
a head portion cut from armor steel plate; and a threaded shaft portion that is welded to an axial surface of the head portion.

2. The bolt apparatus recited in claim 1 wherein said head portion is hex-shaped.

3. The bolt apparatus recited in claim 1 wherein said head portion has a diameter selected to entirely cover an aperture in said armor and prevent a ballistic leak.

4. The bolt apparatus recited in claim 1 wherein said head portion has a thickness selected to stop a selected maximum ballistic threat and prevent projection of said shaft portion into said vehicle.

5. The bolt apparatus recited in claim 1 wherein said threaded portion is welded to said head portion by resistance welding.

6. The bolt apparatus recited in claim 1 wherein said armor steel plate is selected to satisfy either military specification MIL-A12560 or MIL-A-46100.

7. A process for fabricating a bolt for securing armor to a vehicle to increase penetration resistance to ballistic projectiles; the process comprising the step of:
forming a bolt head by cutting an armor steel plate to form said head to provide a selected diameter to cover an aperture in said armor and a selected thickness to withstand a specified ballistic threat; and
affixing a threaded shaft to an axial surface of said bolt head.

8. The process recited in claim 7 wherein said bolt head is formed to have a hexagon shape.

9. The process recited in claim 7 wherein said threaded shaft is affixed to said bolt head by welding.

10. The process recited in claim 9 wherein said welding is carried out by resistance welding.
